(19) United States
(12) Patent Application Publication
(10) Pub. No.: US 2008/0181823 A1
(43) Pub. Date: Jul. 31, 2008

(54) Plate spinner systems and devices

(75) Inventors: Walter Iszczyszyn, Verona, WI (US); Kurt Schicker, Jefferson, WI (US); Paul Thompson, DeForest, WI (US)

Correspondence Address: Casimir Jones, S.C., 440 Science Drive, Suite 203, Madison, WI, 53711, US

(73) Assignee: Third Wave Technologies, Inc., Madison, WI (US)

(21) Appl. No.: 11/594,516

(22) Filed: Nov. 8, 2006

Related U.S. Application Data
(60) Provisional application No. 60/734,482, filed on Nov. 8, 2005.

(51) Int. Cl. B01L 11/00; G01N 37/00

(52) U.S. Cl. 422/99; 73/864.91

(57) ABSTRACT

The present invention provides plate spinner systems and devices, and methods of using such systems and devices. In preferred embodiments, the systems and devices contain one or more of the following features: a manual power generating component (e.g. a hand crank power supply); a rotor assembly composed of a rotor with brackets for securing a sample holding device such as a sample processing device or a micro-titer plate; a rotor hub that supports nearly all of the weight of the rotor assembly; a manually operated brake; and a kettle cover containing a rotor tachometer.

The present application claims priority to U.S. Provisional Application Ser. No. 60/734,482 filed Nov. 8, 2005, which is herein incorporated by reference.

### FIELD OF THE INVENTION

The present invention provides plate spinner systems and devices, and methods of using such systems and devices. In preferred embodiments, the systems and devices contain one or more of the following features: a manual power generating component (e.g. a hand crank power supply); a rotor assembly composed of a rotor with brackets for securing a sample holding device such as a sample processing device or a micro-titer plate; a rotor hub that supports most or all of the weight of the rotor assembly; a manually operated brake; and a kettle cover containing a rotor tachometer.

### BACKGROUND

Many different chemical, biochemical, and other reactions are performed on a variety of sample materials. Although it may be possible to process samples individually and obtain accurate sample-to-sample results, individual processing of samples can be time-consuming and expensive.

One approach to reducing the time and cost of processing multiple samples is to use a sample processing device including multiple chambers in which different portions of one sample or different samples can be processed simultaneously. This approach, however, presents several issues related to distribution of sample materials to the multiple chambers in the devices. In order to distribute a sample, centrifugal force may be applied to force the sample to disperse throughout the sample processing device. What is needed, therefore, are improved sample handling systems, devices, and methods.

### SUMMARY OF THE INVENTION

The present invention provides plate spinner systems and devices, and methods of using such systems and devices. In certain embodiments, the systems and devices contain one or more of the following features: a power generating component (e.g., a hand crank power supply); a rotor assembly composed of a rotor with brackets for securing a sample holding device (e.g. a sample processing device or a micro-titer plate); a rotor hub that supports all or nearly all of the weight of the rotor assembly; a manually operated brake; and a kettle cover containing a rotor tachometer.

In certain embodiments, the present invention provides plate spinner systems and devices comprising; a) a rotor assembly comprising a rotor; b) a drive shaft (e.g. configured to be operably connected to a gear box and a rotor hub); c) a gearbox, wherein the gearbox is operably connected to the drive shaft; d) a manual power generating component (e.g. a hand crank or similar device) operably connected to the gearbox, wherein the manual power generating component is configured to allow a user to manually provide power to the gearbox thereby allowing the gearbox to turn the drive shaft; and e) a rotor hub attached to the rotor, wherein the rotor hub is configured to deliver rotational force from the drive shaft to the rotor. In certain embodiments, the manual power supply is replaced by a non-manual power supply (e.g., an electric power supply).

In further embodiments, the rotor assembly further comprises a plurality of brackets attached to the rotor, wherein the plurality of brackets are configured to secure at least one sample holding device (e.g. a sample processing device, a micro-titer plate, or a test tube) to the rotor. In particular embodiments, the rotor is configured to have secured thereto two, three, four, six or more sample processing devices or micro-titer plates. In some embodiments, the plurality of brackets include stop brackets, side-clamp brackets, or both stop and side-clamp brackets.

In other embodiments, the at least one sample processing device comprises; i) a plurality of process chambers, ii) a plurality of feeder conduits, wherein each of the plurality of feeder conduits is in fluid communication with at least one of the plurality of process chambers, iii) a main conduit which is in fluid communication with the plurality of feeder conduits, and iv) a loading chamber which is in fluid communication with the main conduit. In certain embodiments, at least some of the plurality of process chambers contain assay reagents (e.g. dried assay reagents) for carrying out a biological reaction (e.g. nucleic acid, protein, or other analyte detection reaction). In preferred embodiments, the sample processing device is configured to perform micro-scale reactions (e.g., configured such that one, tow, or a few drops of blood is a sufficient volume to be analyzed in 20-50 separate process chambers).

In particular embodiments, the at least one sample processing device comprises; i) a plurality of process chambers, and ii) a sample processing device connection component. In additional embodiments, the sample processing device is attached to a riser, wherein the riser comprises: i) a flat surface configured to hold the sample processing device, and ii) a riser connection component configured to engage the sample processing device connection component to secure and/or align the sample processing device on the flat surface of the riser. In particular embodiments, the riser prevents the sample processing device from bending or otherwise deviating from a planar position when the sample processing device is on riser.

In certain embodiments, the riser is configured to hold the sample processing device at a height of at least 5 millimeters (e.g., at least 5 or at least 10 millimeters above the surface upon which the riser sits), although other heights are contemplated. In particular embodiments, the riser connection component and the sample processing device connection component are engaged such that the sample processing device is held on the flat surface of the riser in a flat position. In particular embodiments, the flat position is where the plurality of the process chambers are in the same or substantially the same horizontal plane. In particular embodiments, the riser connection component comprises a peg, and the sample processing device connection component comprises an opening (e.g. an opening configured to allow the peg to slide through and secure the two components together). In certain embodiments, the riser comprises a plurality of riser connection components (e.g. 2, 3, 4, 5, 6, 10, 15, etc.). In other embodiments, the riser connection component comprises a latching component configured to lock the sample processing device to the flat surface of the riser (e.g. a part with a latching device that can be used to lock the components together). In particular embodiments, the latching component comprises a lever release to unlock the sample processing device from the flat surface. In certain embodiments, the at least one micro-titer plate is a 96-well, 384-well, or 1536-well micro-titer plate.

In some embodiments, the systems and devices further comprise: i) a brake disc surrounding the drive shaft; ii) a brake, wherein the brake is operably connected to the brake disc, and iii) a brake handle, wherein the brake handle is operably connected to the brake and wherein the brake handle is configured allow a user to stop rotation of the rotor manually (e.g. allows the user to quickly and gently bring the rotor to a stop).

In additional embodiments, the rotor is approximately circular in shape and has a diameter of at least 10 inches (e.g. 10, 12, 14, 16, 17, 17.5, 18, or 20 inches in diameter). In some embodiments, the rotor has a clover-leaf or elliptical shape. In further embodiments, the diameter of the rotor is between about 15 and 20 inches (e.g. 17, 17.5 or 18 inches in diameter). In particular embodiments, the rotor has a plurality of recesses for each sample processing device that allow the riser connection components (e.g. posts that have passed through holes in a sample processing device) to be inserted into the recesses.

In certain embodiments, the rotor hub supports at least 90% of the weight of the rotor assembly (e.g., at least 90%, 93%, 95%, 98%, or 100% of the weight of the rotor assembly). In some embodiments, the rotor hub support all of the weight of the rotor assembly such that no weight is transferred to the shat or crank. Preferably, the rotor supports nearly all the weight of the rotor assembly to remove most of the strain on the drive shaft and gearbox.

In some embodiments, the plate spinner systems and devices further comprise: i) a containment kettle, and/or ii) a kettle cover. In particular embodiments, the rotor assembly is housed (or configured to be housed) in the containment kettle. In additional embodiments, the containment kettle had an opening that is between 10-25 inches in diameter (e.g., 18.0, 20.0, 22.0 inches in diameter), although other dimensions are contemplated. In other embodiments, the plate spinner systems and devices further comprise a tachometer, wherein the tachometer is attached to the kettle cover (e.g. a tachometer configured to give analog rotor revolution information to a user to allow the desired speed and centrifugal force to be obtained). In certain embodiments, the plate spinner systems and devices further comprise: i) a toggle shoe, and ii) a toggle shoe clamp (e.g. to allow the plate spinner to be attached to a work bench or table).

In other embodiments, the present invention provides plate spinner devices or systems comprising; a) a rotor assembly comprising; i) a rotor, and ii) a plurality of brackets attached to the rotor, wherein the plurality of brackets are configured to secure at least one sample holding device (e.g., a sample processing device, or a micro-titer plate, to the rotor); b) a drive shaft (e.g. configured to be operably connected to a gear box and a rotor hub); c) a gearbox, wherein the gearbox is operably connected to the drive shaft; d) a power supply operably connected to the gearbox, wherein the power supply is configured to provide power to the gearbox thereby allowing the gearbox to turn the drive shaft; and e) a rotor hub attached to the rotor, wherein the rotor hub is configured to deliver rotational force from the drive shaft to the rotor.

In some embodiments, the present invention provides plate spinner devices and systems comprising; a) a rotor assembly comprising a rotor; b) a drive shaft; c) a gearbox, wherein the gearbox is operably connected to the drive shaft; d) a power supply operably connected to the gearbox, wherein the power supply is configured to provide power to the gearbox thereby allowing the gearbox to turn the drive shaft; e) a rotor hub attached to the rotor, wherein the rotor hub is configured to deliver rotational force from the drive shaft to the rotor; f) a brake disc surrounding the drive shaft; g) a brake, wherein the brake is operably connected to the brake disc; and h) a brake handle, wherein the brake handle is operably connected to the brake and wherein the brake handle is configured allow a user to stop rotation of the rotor manually.

In other embodiments, the present invention provides plate spinner devices and systems comprising; a) a rotor assembly comprising a rotor; b) a drive shaft; c) a gearbox, wherein the gearbox is operably connected to the drive shaft; d) a power supply operably connected to the gearbox, wherein the power supply is configured to provide power to the gearbox thereby allowing the gearbox to turn the drive shaft; and e) a rotor hub attached to the rotor, wherein the rotor hub is configured to deliver rotational force from the drive shaft to the rotor, and wherein the rotor hub supports at least 90% of the rotor assembly.

In certain embodiments, the present invention provides plate spinner devices and systems comprising; a) a rotor assembly comprising a rotor; b) a drive shaft; c) a gearbox, wherein the gearbox is operably connected to the drive shaft; d) a power supply operably connected to the gearbox, wherein the power supply is configured to provide power to the gearbox thereby allowing the gearbox to turn the drive shaft; e) a rotor hub attached to the rotor, wherein the rotor hub is configured to deliver rotational force from the drive shaft to the rotor; and f) a kettle assembly comprising; i) a containment kettle, and ii) a kettle cover. In additional embodiments, the rotor assembly is housed (or configured to be housed) in the kettle assembly. In other embodiments, the kettle assembly further comprises a tachometer, wherein the tachometer is attached to the kettle cover. In certain embodiments, the tachometer provides analog rotor revolution information.

In particular embodiments, the present invention provides plate spinners and systems comprising: a) a rotor assembly comprising; i) a rotor, ii) a plurality of brackets attached to the rotor, and iii) a least one sample processing device, or at least one micro-titer plate, secured to the rotor by at least a portion of the plurality of brackets; b) a drive shaft; c) a gearbox, wherein the gearbox is operably connected to the drive shaft; d) a power supply operably connected to the gearbox, wherein the power supply is configured to provide power to the gearbox thereby allowing the gearbox to turn the drive shaft; and e) a rotor hub attached to the rotor, wherein the rotor hub is configured to deliver rotational force from the drive shaft to the rotor. In some embodiments, the at least one sample processing device comprises; i) a plurality of process chambers, ii) a plurality of feeder conduits, wherein each of the plurality of feeder conduits is in fluid communication with at least one of the plurality of process chambers, iii) a main conduit which is in fluid communication with the plurality of feeder conduits, and iv) a loading chamber which is in fluid communication with the main conduit. In certain embodiments, the sample processing device is a rectangular in shape with a width of about 3.25 inches and a length of about 6.0 inches.

In certain embodiments, the present invention provides methods of manually operating a plate spinner comprising; a) providing a plate spinner system comprising; i) a rotor assembly comprising a rotor; ii) a drive shaft; iii) a gearbox, wherein the gearbox is operably connected to the drive shaft; iv) a manual power generating component (e.g., a hand crank, stationary bike, etc) operably connected to the gearbox, wherein the manual mechanical energy generating component is configured to allow a user to manually provide power to the gearbox thereby allowing the gearbox to turn the drive shaft; and v) a rotor hub attached to the rotor, wherein the rotor hub is configured to deliver rotational force from the drive shaft to the rotor; and b) manually turning the manual power generating component such that the rotor spins. In certain embodiments, the manual mechanical energy generating component is manually turned such that the rotor spins at a level of at least about 800 rotations per minute (e.g. 800 rpm, . . . 1500 rpm, . . . 2000 rpm, or between 800-1200, etc.). In other embodiments, the manual cranking is performed for about 15 seconds. In some embodiments, the manual crank is turned at about 40 rpm, or about 50 rpm, or about 60 rpm, or between 40-60 rpm. In particular embodiments, at least two runs are performed (e.g. step b) is performed twice (e.g. two runs each performed for about one minute).

In other embodiments, the present invention provides methods of manually operating a plate spinner comprising; a) providing a plate spinner system comprising; i) a rotor assembly comprising; i) a rotor, and ii) a sample holding device (e.g. test tube, EPPENDORF tube, micro-titer plate, sample processing device, etc.), wherein the sample holding device comprises a sample; ii) a drive shaft; iii) a gearbox, wherein the gearbox is operably connected to the drive shaft; iv) a manual power generating component (e.g., a hand crank) operably connected to the gearbox, wherein the manual power generating component is configured to allow a user to manually provide power to the gearbox thereby allowing the gearbox to turn the drive shaft; and v) a rotor hub attached to the rotor, wherein the rotor hub is configured to deliver rotational force from the drive shaft to the rotor; and b) manually turning the manual power generating component such that the rotor spins thereby imparting centrifugal force to the sample (e.g. such that the sample in the sample holding device is spun down, or moves through the device, or causes the sample to mix, etc.).

In other embodiments, the present invention provides methods of moving a sample in a sample processing device using a plate spinner comprising; a) providing a plate spinner system comprising; i) a rotor assembly comprising; i) a rotor, ii) a plurality of brackets attached to the rotor, and iii) a least one sample processing device secured to the rotor by at least a portion of the plurality of brackets, wherein the at least one sample processing device comprises: A) a plurality of process chambers, B) a plurality of feeder conduits, wherein each of the plurality of feeder conduits is in fluid communication with at least one of the plurality of process chambers, C) a main conduit which is in fluid communication with the plurality of feeder conduits, and D) a loading chamber which is in fluid communication with the main conduit, wherein the loading port contains a sample; ii) a drive shaft; iii) a gearbox, wherein the gearbox is operably connected to the drive shaft; iv) a power supply operably connected to the gearbox, wherein the power supply is configured to provide power to the gearbox thereby allowing the gearbox to turn the drive shaft; and v) a rotor hub attached to the rotor, wherein the rotor hub is configured to deliver rotational force from the drive shaft to the rotor; and b) activating the power supply such that the rotor spins thereby imparting centrifugal force to the sample such that at least a portion of the sample travels from the loading chamber to the plurality of process chambers via the main conduit and the plurality of feeder conduits. In certain embodiments, the power supply comprises an electrical power source, and wherein the activating the power supply comprises turning the electrical power source to the on position. In other embodiments, the power supply comprises a hand crank, and wherein the activating the power supply comprises manually turning the hand crank.

In additional embodiments, the present invention provides methods of manually stopping the spinning of a rotor in a plate spinner comprising; a) providing a plate spinner system comprising; i) a rotor assembly comprising a rotor, wherein the rotor is spinning; ii) a drive shaft; iii) a gearbox, wherein the gearbox is operably connected to the drive shaft; iv) a power supply operably connected to the gearbox, wherein the power supply is configured to provide power to the gearbox thereby allowing the gearbox to turn the drive shaft; v) a rotor hub attached to the rotor, wherein the rotor hub is configured to deliver rotational force from the drive shaft to the rotor; and vi) a brake disc surrounding the drive shaft; vii) a brake, wherein the brake is operably connected to the brake disc; and viii) a brake handle, wherein the brake handle is operably connected to the brake and wherein the brake handle is configured allow a user to stop rotation of the rotor manually; and b) manually operating the brake handle such that the rotor stops spinning.

In certain embodiments, the present invention provides systems or plate spinner components comprising; a) a rotor assembly comprising; i) a rotor, and ii) a plurality of brackets attached to the rotor, wherein the plurality of brackets are configured to secure at least one sample processing device, or micro-titer plate, to the rotor; and b) a rotor hub configured to attach to the rotor and deliver rotational force from a drive shaft to the rotor. In particular embodiments, the at least one sample processing device comprises; i) a plurality of process chambers, ii) a plurality of feeder conduits, wherein each of the plurality of feeder conduits is in fluid communication with at least one of the plurality of process chambers, iii) a main conduit which is in fluid communication with the plurality of feeder conduits, and iv) a loading chamber which is in fluid communication with the main conduit.

In other embodiments, the present invention provides systems or plate spinner components comprising; a) a plate spinner containment kettle, b) a tachometer, and c) a plate spinner kettle cover, wherein the tachometer is attached to the plate spinner kettle cover. In particular embodiments, the tachometer provides analog rotor revolution information.

### DEFINITIONS

To facilitate an understanding of the present invention, a number of terms and phrases are defined below:

As used herein, the term “sample” is used in its broadest sense. Examples of samples include, but are not limited to, blood, saliva, cerebral spinal fluid, pleural fluid, milk, lymph, sputum, semen, or any aqueous or semi-aqueous mixture that contains nucleic acid or protein to be detected.

As used herein, the term “sample processing device” refers to a device where a sample can be loaded at one location and then portions of the sample may be moved (e.g. by centrifugal force) to a plurality of process chambers within the device for analysis by assays involving chemical or biological reactions. One example of a sample processing devices is shown in FIG. 13.

### DESCRIPTION OF THE DRAWINGS

FIG. 1A shows a side view of the outside surface of one embodiment of a plate spinner system and device 70. FIG. 1B shows an elevated top and side view of one embodiment of plate spinner 70.

FIG. 2 shows a side view of one embodiment of a plate spinner 70 which shows a brake handle 20 and a plate spinner hand crank 12.

FIG. 3 shows a side cut away side view of one embodiment of a plate spinner 70.

FIG. 4 shows a different side cut away view of one embodiment of a plate spinner 70.

FIG. 5 shows another side cut away view of one embodiment of a plate spinner 70.

FIG. 6A shows a side cut away view of one embodiment of a plate spinner 70 with a circled area of detail that is shown in FIG. 6B.

FIGS. 7A and 7B show two views of one embodiment of rotor hub 48.

FIG. 8A shows one embodiment of rotor 5 sitting on associated rotor hub 48.

FIG. 9 shows the upper portion of one embodiment of plate spinner 70, including a kettle cover 6 and containment kettle 43, which combine to enclose rotor 5.

FIG. 10 shows a bottom view of one embodiment of containment kettle 43, sitting atop kettle skirt 44.

FIG. 11 shows one embodiment of brake disc 3, for drive shaft 16, with associated brake 2.

FIG. 12A shows a top view of one embodiment of kettle cover 6 with two round grip handles 77 and a tachometer 71. FIG. 12B shows a side view of one embodiment of kettle cover 6 and tachometer 71 which includes a tachometer step assembly 78.

FIG. 13A shows one embodiment of a sample processing device 49 including a plurality of process arrays 53. FIG. 13B shows one embodiment of process chamber 59 defining a volume 66 that may include a reagent 67.

### DESCRIPTION OF THE INVENTION

The present invention provides plate spinner systems and devices, and methods of using such systems and devices. In preferred embodiments, the systems and devices contain one or more of the following features: a manual power generating component (e.g., a hand crank power supply); a rotor assembly composed of a rotor with brackets for holding a sample holding device (e.g., a sample processing device or micro-titer plate); a rotor hub that supports nearly all of the weight of the rotor assembly; a manually operated brake; and a kettle cover containing a rotor tachometer.

The plate spinner systems and devices of the present invention allow ease of use and portability to the sample holding device (e.g. microtiter plate) user in need of centrifugation (e.g. low speed centrifugation). In preferred embodiments, the plate spinner systems and devices of the present invention are configured to be secured to standard counter or bench tops. Preferably, the plate spinner contains a hand crank, or similar device, in order to provide motive force to the plate spinner. In certain embodiments, the rotor is able to accommodate 2 or 4 sample holding devices (e.g., micro-titer plates or sample processing devices of standard dimensions). In other embodiments, two or sample processing devices are stacked at each location on the rotor. For example, if the rotor has four areas for holding sample holding devices, two or three such plates or devices could be at each area for a total of eight or twelve sample processing devices on the rotor. In other embodiments, the plate spinner contains a cover (e.g. kettle assembly) to preserve sample integrity from environmental contamination, and/or a brake to assist in stopping the rotation of the plate spinner. In certain embodiments, the plate spinner does not contain a brake.

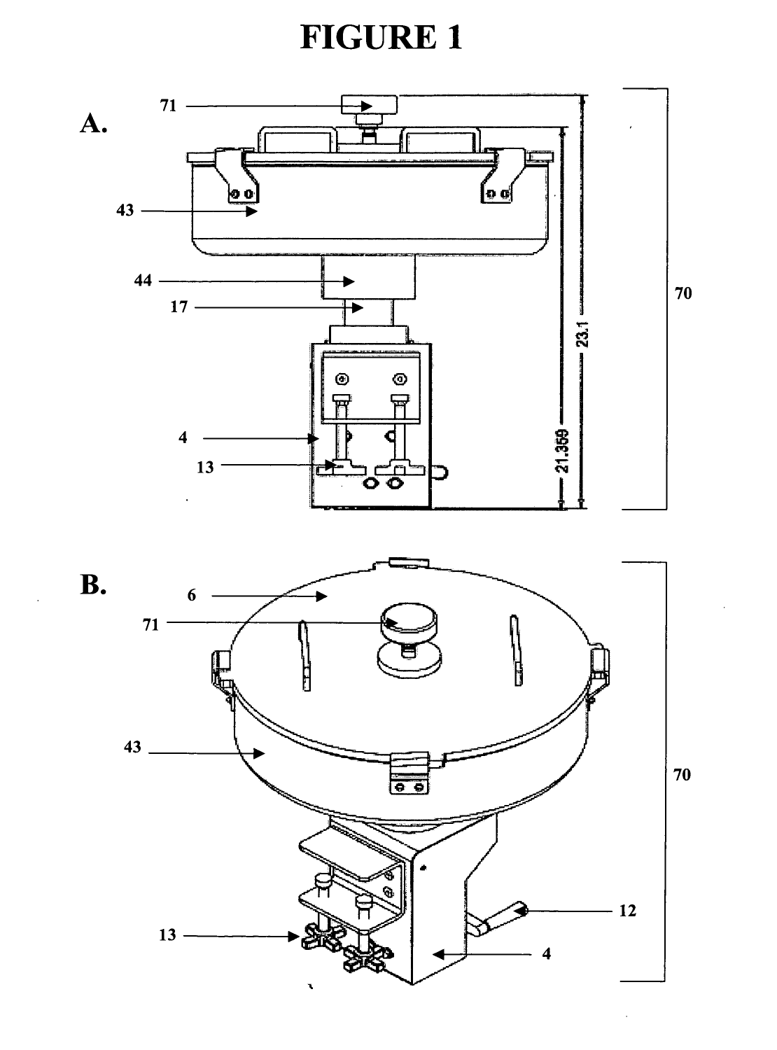

FIGS. 1-13 provide exemplary plate spinner systems and devices, and components therefore. These figures are exemplary and are not intended to limit the present invention.

FIG. 1A shows a side view of the outside surface of a plate spinner system and device 70. The plate spinner 70 incorporates a tachometer 71, which provides analog rotor revolution information (e.g. to ensure that the desired speed and centrifugal force is obtained). The plate spinner has a containment kettle 43 that surrounds and creates the interior space of the plate spinner (e.g. the space where micro-fluidic, test tubes, or other components may be placed in order to be subjected to centrifugal force). Below the containment kettle 43 is a kettle skirt 44, which sits above the plate spinner torque tube 17. The gears and other internal components are housed in the gearbox assembly 4. Two toggle shoe clamps 13 may be used to secure the plate spinner to a surface (e.g. lab workbench surface).

FIG. 1B shows an elevated top and side view of the plate spinner 70. This figure, besides showing the tachometer 71, containment kettle 43, gearbox assembly 4, and toggle shoe clamps 13, also shows a removable kettle cover 6 with two handles. Kettle cover 6 is designed to protect any samples in the plate spinner from environmental contamination. Also shown in FIG. 1B is a hand crank 12. The hand crank 12 may be used to provide power to the plate spinner (e.g., to cause the rotor to rotate such that centrifugal force is applied to any sample contained in the plate spinner).

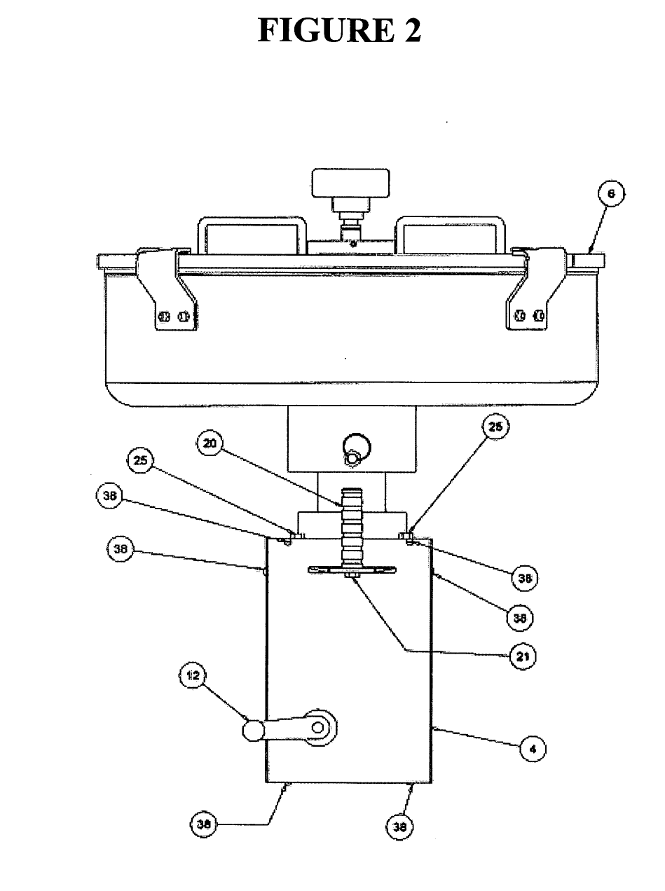

FIG. 2 shows a side view of a plate spinner 70 which shows a brake handle 20 and a plate spinner hand crank 12. The brake handle 20 may be employed by a user, for example, to stop the rotations of the drive shaft and rotor. The plate spinner hand crank 12, which is attached via bolt 21, may be used be used to provide power to the plate spinner. FIG. 2 also shows various bolts 25 and screws 38 used to assemble the plate spinner gearbox assembly 4. Also shown in FIG. 2 is a side view of kettle cover 6.

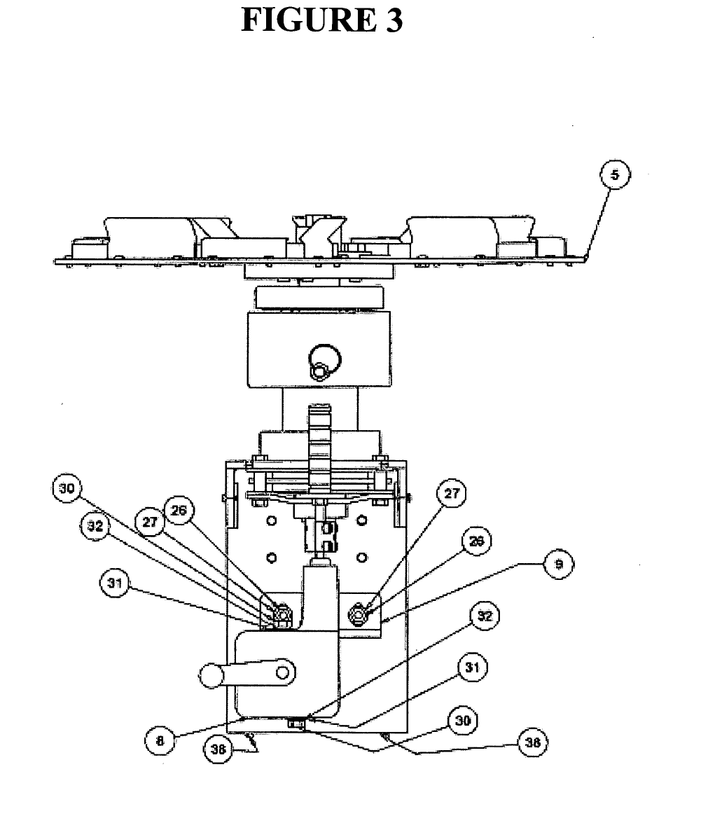

FIG. 3 shows a side cut away view of a plate spinner 70. Near the top of the device is the rotor 5, shown with various components that may be used to secure sample holding devices such as sample processing devices and micro-titer plates. Also shown attached to the plate spinner hand crank 12 is gearbox 8 (e.g. which may be a HETTICH gearbox or similar type gearbox). Also shown in this figure are the following: clamp angle connection to plate spinner 9, nuts 26, flat washers 27, hex bolts 30, flat washers 31, lock washers 32, and pan head screws 38.

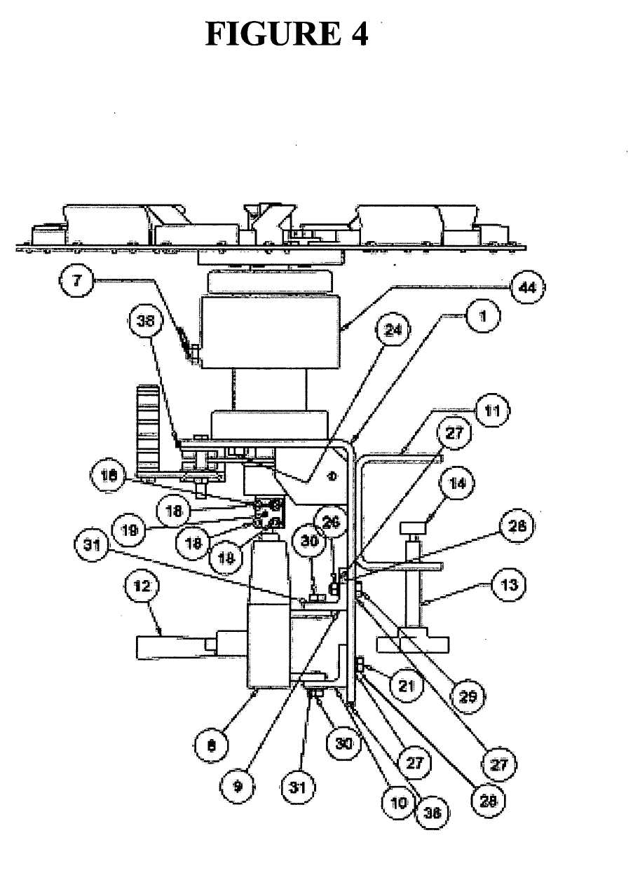

FIG. 4 shows a different side cut away view of plate spinner 70. Kettle skirt 44 is shown below the rotor. Kettle skirt 44 may have an associated retractable spring plunger assembly 7, which may be used, for example, to attach the kettle to the hub, and subsequently allow easy removal of the kettle for cleaning and decontamination. A plate spinner clamp lower horizontal plate 11 is attached to the plate spinner gearbox assembly 1, and may be used as the attachment point for toggle shoe clamp 13 and associated toggle shoe 14. Various additional components are shown in this figure, including the following: gearbox 8 and associated plate spinner hand crank 12, plate spinner shaft 16, screws 18 and 19, hex bolt 24, nuts 26, flat washers 27, locker washers 28, hex bolts 29, hex bolts 30, flat washers 31, lock washers 32, and pan head screws 38.

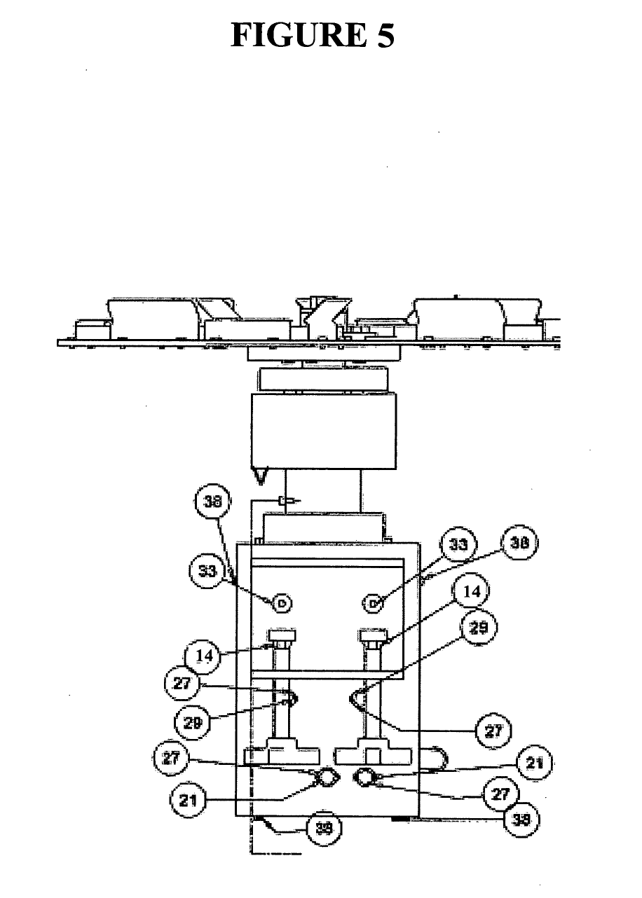

FIG. 5 shows another side cut away view of plate spinner 70. This figures shows four pan head screws 38, two FHCSs 33 (flat head socket cap screws), four flat washers 27, two hex bolts 29, and two hex bolts 21. Also shown are two toggle shoes 14.

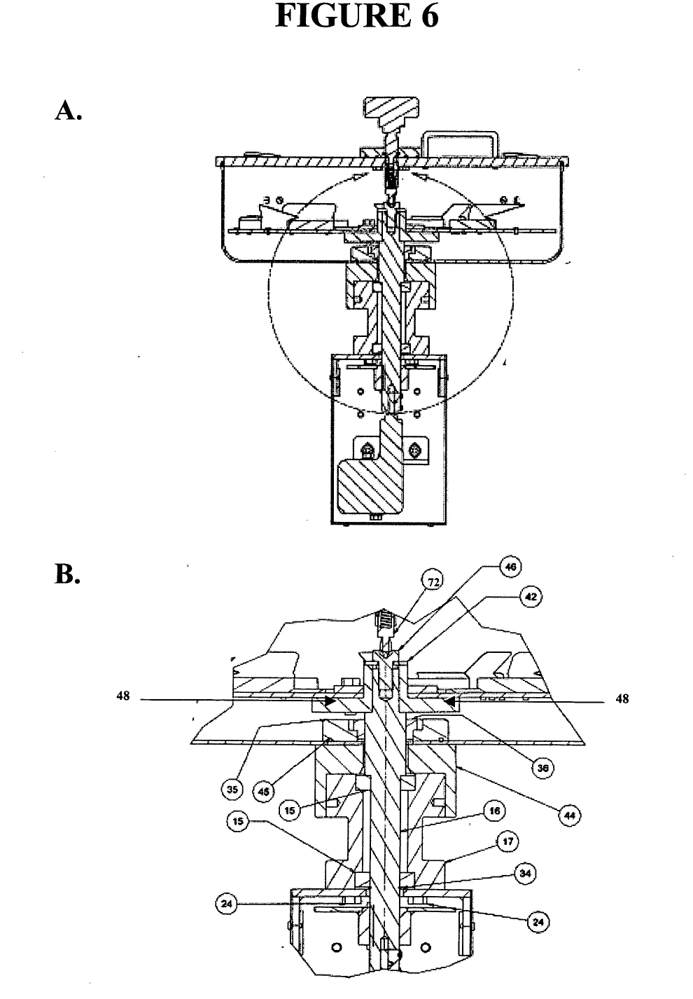

FIG. 6A shows a side cut away view of plate spinner 70 with a circled area of detail that is shown in FIG. 6B. FIG. 6B shows a tachometer retractable spring assembly 72, a left hand hex bolt with a 1 inch long counter sunk head 46, a plate spinner top located hub clamp plate 42, a seal mount 35, a rotor seal (LSE-flange design/external seal) 36, an O-ring 45, a kettle skirt 44, and a rotor hub 48. Also shown in this figure is a one inch bearing 15, a plate spinner shaft 16, a plate spinner torque tube 17, a one inch snap ring 34, and two hex bolts 24.

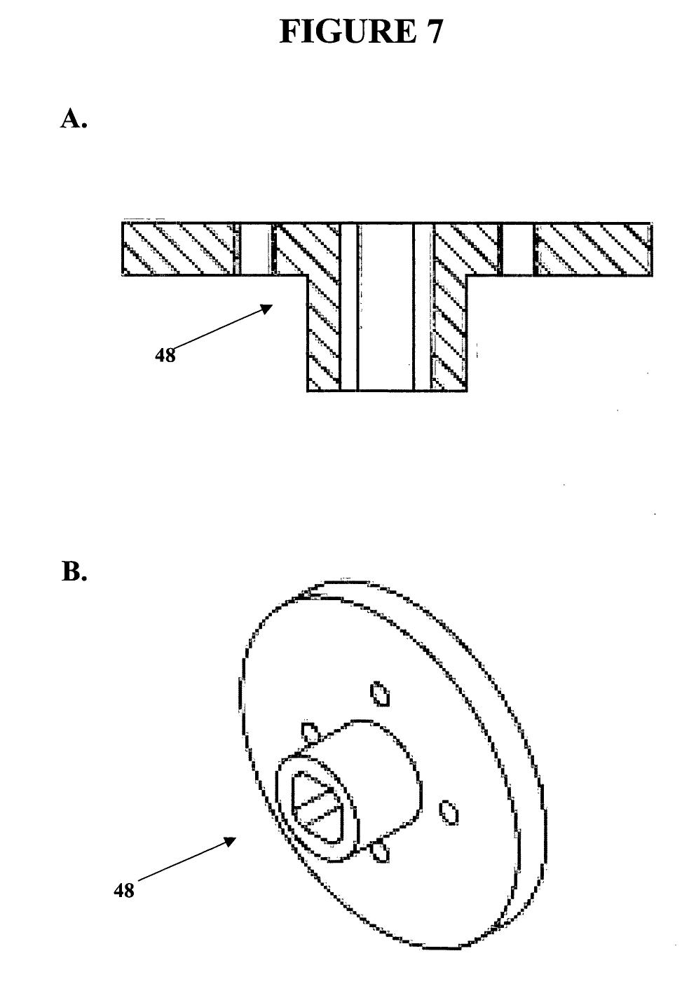

FIGS. 7A and 7B show two views of rotor hub 48. Rotor hub 48 is configured to surround the drive shaft 16, delivering rotational force from the plate spinner to the rotor 5. In preferred embodiments, the hub 48 supports nearly all of the weight of the rotor assembly thereby removing this strain from the drive shaft and plate spinner gearbox assembly.

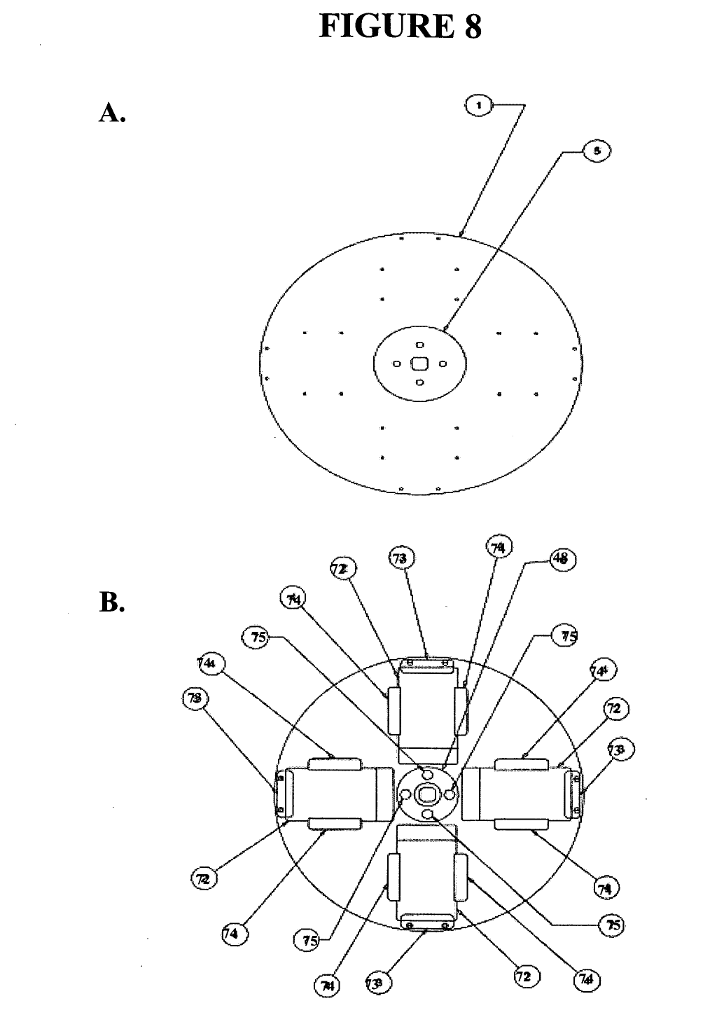

FIG. 8A shows a rotor 5 sitting on associated rotor hub 48 shown with four hex bolts 75. The rotor 5 is shown with six holes for attachment to stop and side brackets configured for holding a sample processing device. FIG. 8B shows a rotor 5, and associated rotor hub 48, containing four sample processing devices 49. Each sample processing device 49 is held in place via a stop bracket 73 and two side clamp brackets 74.

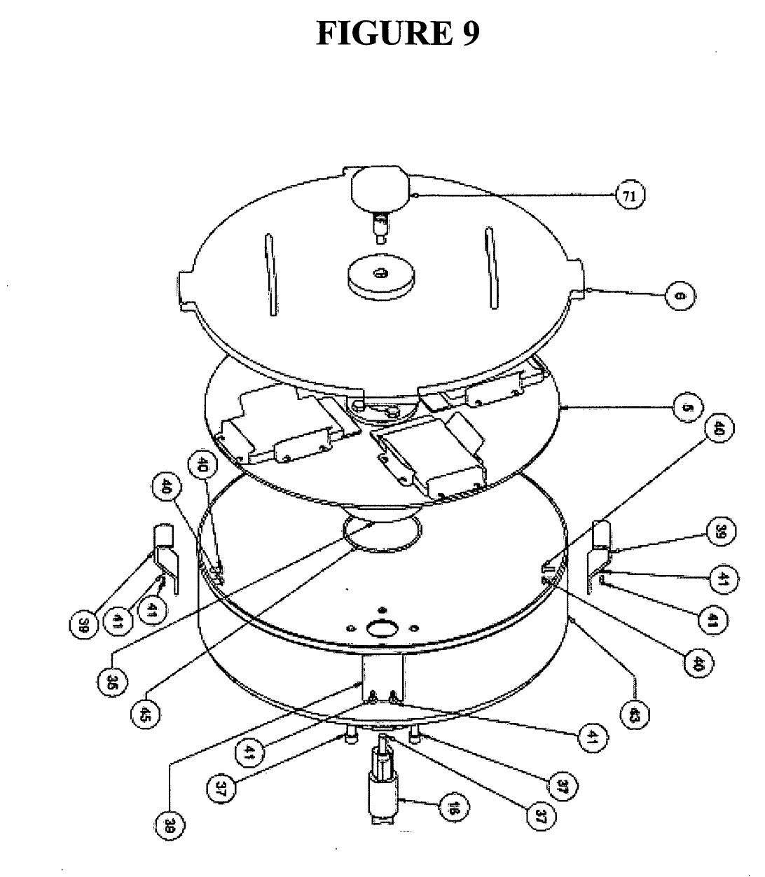

FIG. 9 shows the upper portion of plate spinner 70, including a kettle cover 6 and containment kettle 43, which combine to enclose rotor 5 (which has a number of sample processing devices attached thereto). A tachometer 71 is shown that sits atop and extends through the kettle cover 6. A drive shaft 16 is shown to extend through the containment kettle 43 to supply power to rotor 5. Also shown in this figure are two SHCS 37 (socket head cap screw), six nuts 41, three lid clamp plates 39, four pan head screws 40, a seal mount 35, and an O-ring 45.

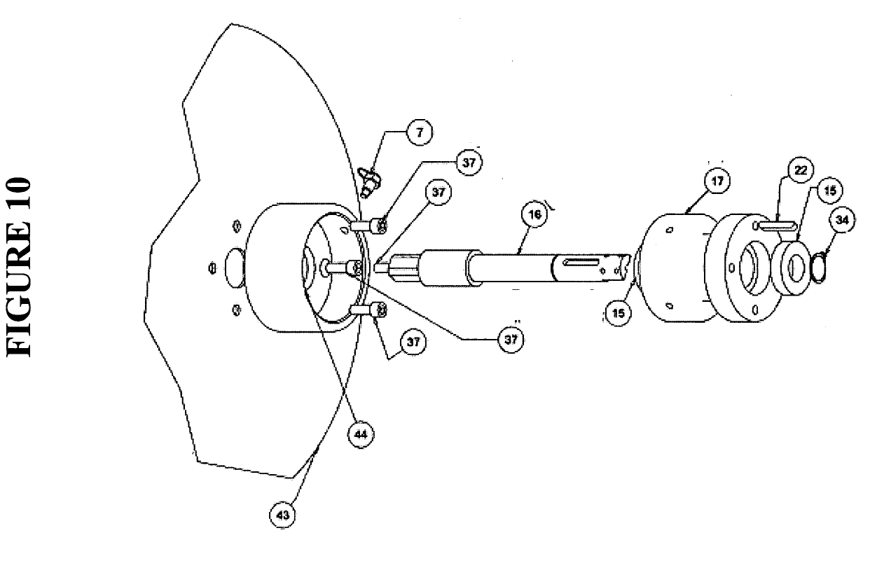

FIG. 10 shows a bottom view of containment kettle 43, sitting atop kettle skirt 44. Four SHCSs 37 can be used to attach the kettle skirt 44 to containment kettle 43. Also shown in this figure is drive shaft 16, two bearings 15, plate spinner torque tube 17, shaft snap ring 34, key stock 22, and retractable spring plunger assembly 7.

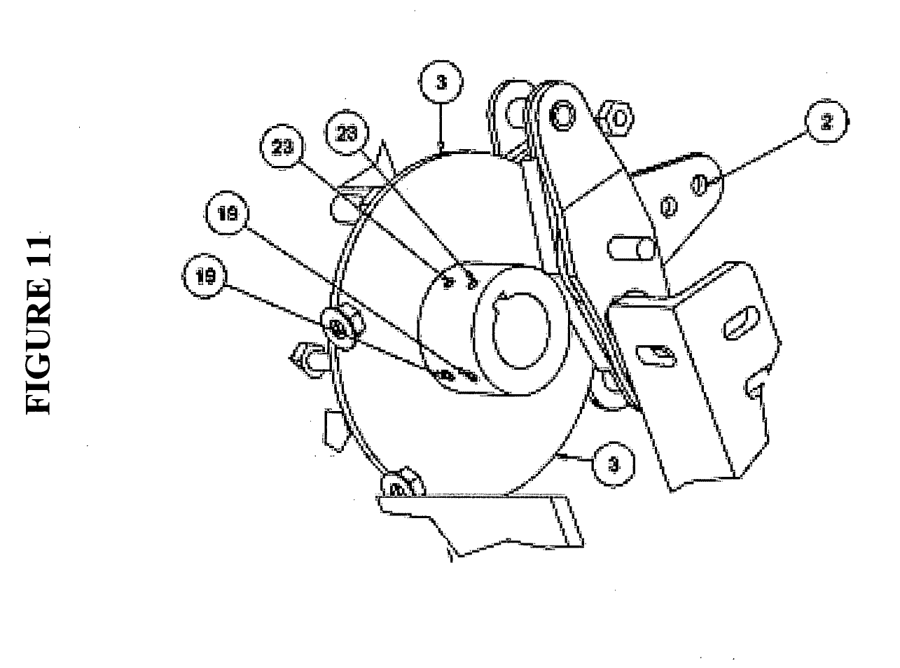

FIG. 11 shows a brake disc 3, for drive shaft 16, with associated brake 2. The break 2, which is attached to brake handle 20 (not shown in this figure) may be used to quickly and gently bring the rotor to a stop to facilitate speed of use of the plate spinner (e.g. in applications where full-coast deceleration is not required). Also shown in this figure as part of the hub and disc assembly 3 are two set screws 19 and two set screws 23.

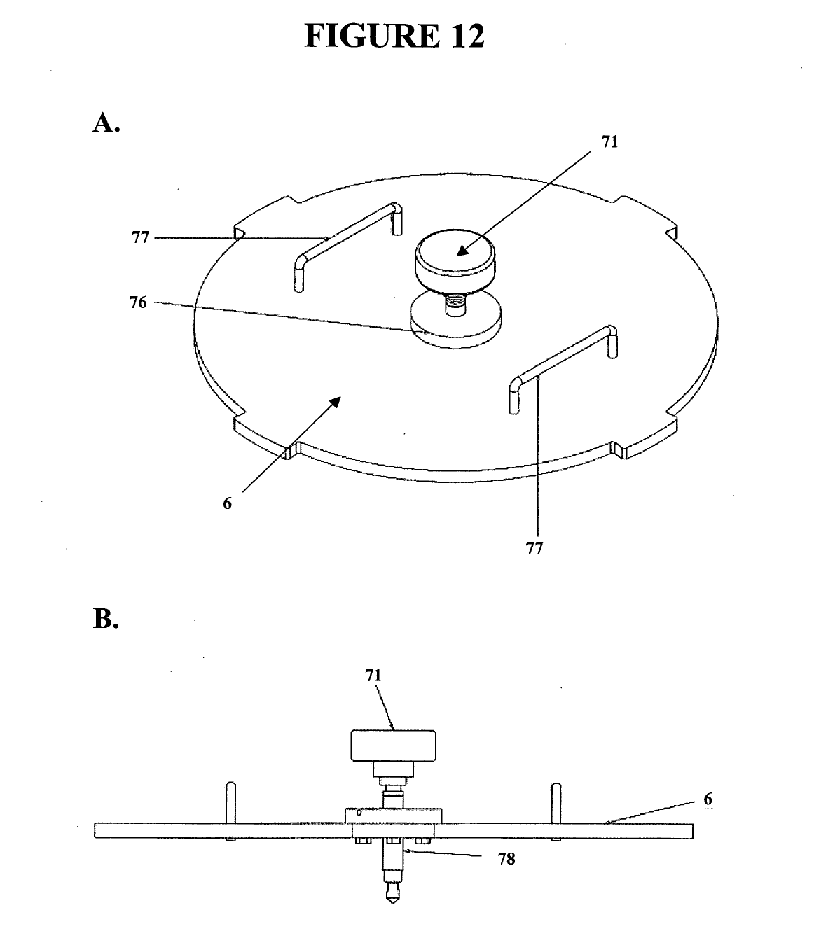

FIG. 12A shows a top view of kettle cover 6 with two round grip handles 77 and a tachometer 71. FIG. 12B shows a side view of kettle cover 6 and tachometer 71 which includes a tachometer stem extension assembly 78.

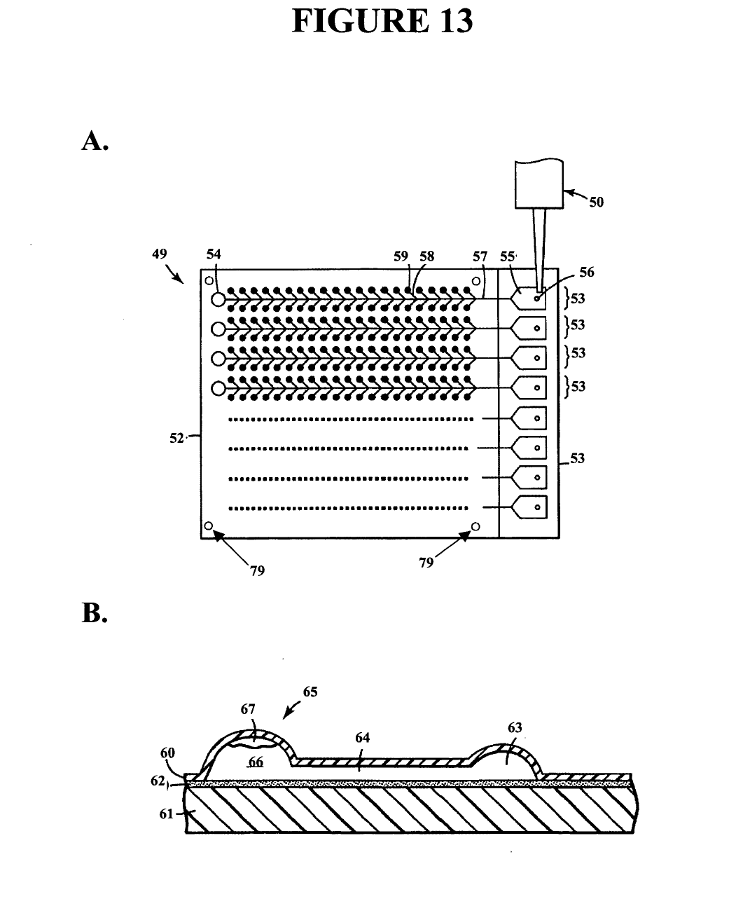

The present invention is not limited by the type of sample processing devices used with the plate spinner systems and devices of the present invention. Numerous microufluidic sample processing devices are known in the art. Examples of such devices, and methods for making and using such devices, are described in the following patents and applications: U.S. Pat. No. 6,627,159; U.S. Pat. No. 6,720,187; U.S. Pat. No. 6,734,401; U.S. Pat. No. 6,814,935; U.S. Application 2002/0064885; and U.S. Application 2003/0152994; all of which are herein incorporated by reference for all purposes. The plate spinner systems and devices of the present invention may also be used with the sample processing devices described in co-pending provisional application Ser. No. 60/659,622, which is herein incorporated by reference. One illustrative sample processing device is shown in FIGS. 13A and 13B. This illustrative sample processing device is described below as one type of sample processing device that could be used with the plate spinner devices and systems of the present invention and is not intended to limit the type of sample processing devices that may be employed.

Briefly, FIG. 13A shows a sample processing device 49 includes at least one, and preferably a plurality of process arrays 53. Each of the process arrays 53 extends from a first end 51 towards a second end 52 of the sample processing device 49. Although the process arrays 53 are depicted as being substantially parallel in their arrangement on the sample processing device 49, such arrays need not necessarily be parallel. Alignment of the process arrays 53 between the first and second ends 51 and 52 is preferred because sample materials may be distributed throughout the sample processing device by rotation about an axis of rotation proximate the first end 51 of the device 49 using the plate spinner devices and systems of the present invention.

As shown in FIG. 13A, each of the process arrays 53 includes at least one loading chamber 55, at least one main conduit 57, and a plurality of process chambers 59 located along each main conduit 57. It may be preferred that each of the process arrays include only one loading chamber 55 and only one main conduit 57. The process chambers 59 are in fluid communication with the main conduit 57 through feeder conduits 58. As a result, the loading chamber 55 in each of the process arrays 53 is in fluid communication with each of the process chambers 59 located along the main conduit 57 leading to the loading chamber 55. In certain embodiments, the sample processing device contains one or more sample processing device connection components 79 (e.g. holes) that may be used, for example, to align and attached the sample processing device with a riser. The riser may be used, for example, to keep the sample processing device from bending or otherwise deforming while in the plate spinner.

Each of the loading chambers 55 includes an inlet port 56 for receiving sample material into the loading chamber 55. The sample material may be delivered to port 56 by any suitable technique and/or equipment. A pipette 50 is depicted in FIG. 13A, but is only one technique for loading sample material into the loading chambers 55. The pipette 50 may be operated manually or may be part of an automated sample delivery system for loading the sample material into loading chambers 55 a sample processing device 49.

Each of the loading structures 55 depicted in FIG. 13A may also include a vent port with the loading chamber 55. The inlet port 56 and the vent port may preferably be located at the opposite ends of the legs of a U-shaped loading chamber. Locating the inlet port 56 and the vent port at opposite ends of the legs of a U-shaped loading chamber may assist in filling of the loading chamber 55 by allowing air to escape during filling of the loading chamber 55.

FIG. 13B shows a process chamber 59 defining a volume 66 that may include a reagent 67. The process chamber 59 may contain at least one reagent before any sample material is distributed to the process chambers. The reagent 67 may be fixed within the process chamber 59 as depicted in FIG. 13B.

FIG. 13B also depicts, within the sample processing device 49, a first major side 60 and a second major side 61, between which the volume 66 of process chamber 59 is formed. Also depicted in FIG. 13B is a portion of feeder conduit 58 used to deliver sample material to the process chamber 59. The major sides 60 and 61 of the device 49 may be manufactured of any suitable material or materials. Examples of suitable materials include polymeric materials (e.g., polypropylene, polyester, polycarbonate, polyethylene, etc.), metals (e.g., metal foils), ceramics, etc. At least one of the first and second major sides 60 and 61 may be constructed of a material or materials that substantially transmit electromagnetic energy of selected wavelengths that allow for visual or machine monitoring of fluorescence or color changes within the process chambers 59. At least one of the first and second major sides 60 and 61 may be in the form of a metallic foil, which may include a passivation layer on the surfaces that face the interiors of the loading chambers 55, main conduits 57, feeder conduits 58, and/or process chambers 59 to prevent contamination of the sample materials.

In the illustrative embodiment of the sample processing device depicted in FIGS. 13A and 13B, the first major side 60 may be manufactured of a polymeric film (e.g., polypropylene) that is formed to provide structures such as the loading chambers 55, main conduit 57, feeder conduits 58, and process chambers 59. The second major side 61 is may be manufactured of a metallic foil, e.g., an aluminum or other metal foil. The metallic foil is preferably deformable. The first and second major sides 60 and 61 may be attached by any suitable technique or techniques, for example, heat sealing, ultrasonic welding, adhesive, etc. As depicted in FIG. 13B, adhesive may preferably be provided in the form of a layer of adhesive 62. It may be preferred that the adhesive layer 62 be provided as a continuous, unbroken layer over the surface of at least one of the first and second major sides 60 and 61. It may be that the adhesive layer 62 be provided on the metallic foil of major side 61. Any adhesive selected should be capable of withstanding the forces generated during processing of any sample materials located in the process chambers 59. The adhesives may include, for example, hot melt adhesives, curable adhesives, pressure sensitive adhesives, etc. Pressure sensitive adhesives may be used in connection with the sample processing devices that are resistant to high temperatures and humidity, such as silicone pressure sensitive adhesives (see, U.S. Pat. Nos. 5,461,134 and 6,007,914 or International Publication No. WO 96/35458 all of which are herein incorporated by reference).

Any type of reagents may be used with the sample processing devices in the plate spinners of the present invention, including reagents for INVADER assays, TAQMAN assays, sequencing assays, polymerase chain reaction assays, hybridization assays, hybridization assays employing a probe complementary to a mutation, bead array assays, primer extension assays, enzyme mismatch cleavage assays, branched hybridization assays, rolling circle replication assays, NASBA assays, molecular beacon assays, cycling probe assays, ligase chain reaction assays, sandwich hybridization assays, protein/protein assays, LLC, antibody based assays, etc. In preferred embodiments, reagents that allow for the formation and cleavage of invasive cleavage structures are employed (e.g., INVADER assay components used for performing INVADER detection assays). These reagents provides nucleotide sequences and enzymes for forming a nucleic acid cleavage structure that is dependent upon the presence of a target nucleic acid and cleaving the nucleic acid cleavage structure so as to release distinctive cleavage products. 5′ nuclease activity, for example, is used to cleave the target-dependent cleavage structure and the resulting cleavage products are indicative of the presence of specific target nucleic acid sequences in the liquid sample that is loaded into the sample processing device. When two strands of nucleic acid, or oligonucleotides, both hybridize to a target nucleic acid strand such that they form an overlapping invasive cleavage structure, as described below, invasive cleavage can occur. Through the interaction of a cleavage agent (e.g., a 5′ nuclease) and the upstream oligonucleotide, the cleavage agent can be made to cleave the downstream oligonucleotide at an internal site in such a way that a distinctive fragment is produced. Such embodiments have been termed the INVADER assay (Third Wave Technologies) and are described in U.S. Pat. Nos. 5,846,717; 5,985,557; 5,994,069; 6,001,567; 6,913,881; and 6,090,543, WO 97/27214, WO 98/42873, Lyamichev et al., Nat. Biotech., 17:292 (1999), Hall et al., PNAS, USA, 97:8272 (2000), each of which is herein incorporated by reference in their entirety for all purposes). The INVADER assay detects hybridization of probes to a target by enzymatic cleavage of specific structures by structure specific enzymes.

In certain embodiments, the assays performed in the sample holding devices are protein based assays. Examples of such assays include, but are not limited to, Lowry, Modified Lowry, Biuret, Bradford assay, cell based assays, ELISAs, antibody binding assays, etc. In some embodiments, the assays are run on solid support in the sample processing devices, while in other embodiments, the assays are run in aqueous phase.

In certain embodiments, the plate spinners of the present invention are operably linked to a computer component. In some embodiments, the compute component directs the operation of the plate spinner (e.g. turning it on, providing energy, stopping the rotor on a pre-set schedule, etc.). In additional embodiments, the computer component monitors the plate spinner or various components of the plate spinner. In other embodiments, the plate spinners of the present invention are integrated with one or more sample readers. Integrated sample readers allow, for example, one to monitor reactions in sample processing devices that are attached to the rotor of the plate spinners of the present invention. Sample readers may be configured to detect any type of signal, including, for example, fluorescence, V, luminescence, mass spectrometry, etc.

All publications and patents mentioned in the above specification are herein incorporated by reference as if expressly set forth herein. Various modifications and variations of the described invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in relevant fields are intended to be within the scope of the following claims.

We claim:

1. A plate spinner device comprising;
a) a rotor assembly comprising; i) a rotor, and ii) a plurality of brackets attached to said rotor, wherein said plurality of brackets are configured to secure at least one sample processing device, or at least one micro-titer plate, to said rotor;
b) a drive shaft;
c) a gearbox, wherein said gearbox is operably connected to said drive shaft;
d) a power supply operably connected to said gearbox, wherein said power supply is configured to provide power to said gearbox thereby allowing said gearbox to turn said drive shaft; and
e) a rotor hub attached to said rotor, wherein said rotor hub is configured to deliver rotational force from said drive shaft to said rotor.

2. The device of claim 1, wherein said power supply comprises a manual power generating component configured to allow a user to manually provide power to said gearbox thereby allowing said gearbox to turn said drive shaft.

3. The device of claim 2, wherein said manual power generating component comprises a hand crank.

4. The device of claim 1, wherein said at least one sample processing device comprises; i) a plurality of process chambers, ii) a plurality of feeder conduits, wherein each of said plurality of feeder conduits is in fluid communication with at least one of said plurality of process chambers, iii) a main conduit which is in fluid communication with said plurality of feeder conduits, and iv) a loading chamber which is in fluid communication with said main conduit.

5. The device of claim 1, further comprising: i) a brake disc surrounding said drive shaft; ii) a brake, wherein said brake is operably connected to said brake disc, and iii) a brake handle, wherein said brake handle is operably connected to said brake and wherein said brake handle is configured allow a user to stop rotation of said rotor manually.

6. The device of claim 1, wherein said rotor is approximately circular in shape and has a diameter of at least 10 inches.

7. The device of claim 1, wherein said rotor hub supports at least 90% of the weight of said rotor assembly.

8. The device of claim 1, further comprising: a containment kettle and a kettle cover.

9. The device of claim 8, wherein said rotor assembly is housed in said containment kettle.

10. The device of claim 8, further comprising a tachometer, wherein said tachometer is attached to said kettle cover.

11. The device of claim 1, further comprising: i) a toggle shoe, and ii) a toggle shoe clamp.

12. A plate spinner device comprising;
a) a rotor assembly comprising; i) a rotor, ii) a plurality of brackets attached to said rotor, and iii) a least one sample processing device, or at least one micro-titer plate, secured to said rotor by at least a portion of said plurality of brackets;
b) a drive shaft;
c) a gearbox, wherein said gearbox is operably connected to said drive shaft;
d) a power supply operably connected to said gearbox, wherein said power supply is configured to provide power to said gearbox thereby allowing said gearbox to turn said drive shaft; and
e) a rotor hub attached to said rotor, wherein said rotor hub is configured to deliver rotational force from said drive shaft to said rotor.

13. The device of claim 12, wherein said rotor assembly comprises said at least one sample processing device, and wherein said at least one sample processing device comprises; i) a plurality of process chambers, ii) a plurality of feeder conduits, wherein each of said plurality of feeder conduits is in fluid communication with at least one of said plurality of process chambers, iii) a main conduit which is in fluid communication with said plurality of feeder conduits, and iv) a loading chamber which is in fluid communication with said main conduit.

14. A method of manually operating a plate spinner comprising;
a) providing a plate spinner system comprising;
i) a rotor assembly comprising; i) a rotor, and ii) a sample holding device, wherein said sample holding device comprises a sample;
ii) a drive shaft;
iii) a gearbox, wherein said gearbox is operably connected to said drive shaft;
iv) a manual power generating component operably connected to said gearbox, wherein said manual power generating component is configured to allow a user to manually provide power to said gearbox thereby allowing said gearbox to turn said drive shaft; and
v) a rotor hub attached to said rotor, wherein said rotor hub is configured to deliver rotational force from said drive shaft to said rotor; and
b) manually turning said manual power generating component such that said rotor spins thereby imparting centrifugal force to said sample.

15. The method of claim 14, wherein said sample holding device is selected from a test tube, sample processing device, and a micro-titer plate.

16. The method of claim 14, wherein said sample holding device is a sample processing device comprising i) a plurality of process chambers, and ii) a loading chamber which is in fluid communication with said plurality of process chambers, wherein said loading chamber contains said sample, and wherein said centrifugal force imparted to said sample causes at least a portion of said sample to travel from said loading chamber to said plurality of process chambers.

17. The method of claim 14, further comprising: i) a brake disc surrounding said drive shaft; ii) a brake, wherein said brake is operably connected to said brake disc, and iii) a brake handle, wherein said brake handle is operably connected to said brake and wherein said brake handle is configured allow a user to stop rotation of said rotor manually.

18. The method of claim 14, wherein said rotor is approximately circular in shape and has a diameter of at least 10 inches.

19. The method of claim 14, wherein said rotor hub supports at least 90% of the weight of said rotor assembly.

20. The method of claim 14, further comprising: a containment kettle and a kettle cover.
